(19) United States
(12) Patent Application Publication
(10) Pub. No.: US 2010/0054903 A1
(43) Pub. Date: Mar. 4, 2010

(54) Method and Device for Manipulating an Object

(76) Inventors: Christopher Vernon Jones, Woburn, MA (US); Erik Edward Steltz, Melrose, MA (US); Annan Michael Mozeika, Winchester, MA (US)

Correspondence Address: O'Brien Jones, PLLC (w/iRobot Corp.), 8200 Greensboro Drive, Suite 1020A, McLean, VA, 22102, US

(21) Appl. No.: 12/553,971

(22) Filed: Sep. 3, 2009

Related U.S. Application Data
(60) Provisional application No. 61/094,049, filed on Sep. 3, 2008.

(51) Int. Cl. B25J 15/00; B66C 1/44

(52) U.S. Cl. 414/800; 294/86.4; 294/88

(57) ABSTRACT

A method for manipulating an object with a remote vehicle having an end effector attached to a manipulator arm. The end effector comprises a jamming material in a housing. The method comprises pressing the end effector housing to the object, activating the jamming material to grasp the object, and moving the manipulator arm to manipulate the object.

### INTRODUCTION

The present teachings relate to a device for use with a remote vehicle having a manipulator arm. The device assists the manipulator arm in manipulating certain graspable objects. A method for manipulating an object is also contemplated by the present teachings.

### BACKGROUND

It is known to use remote vehicles such as robots to manipulate objects. Typically, remote vehicles include a manipulator arm specifically for the purpose of manipulating objects. Manipulator arms can typically include distally-located end effectors such as two-, three-, and four-fingered grippers (an other end effectors) for manipulation. Such manipulation can include, for example, grasping and moving objects by opening and closing the gripper fingers. More complex manipulation can include opening doors.

Existing two-, three-, and four-fingered grippers (an other end effectors) can be less effective for picking up or grasping smaller objects, for example a wire or a pencil-sized object from the ground. Remote vehicles are controlled via telemanipulation by a trained operator. Extensive training and practice may be required to become proficient in using grippers for certain tasks, for example picking up smaller objects and/or performing more complex tasks such as door opening.

### SUMMARY

Certain embodiments of the present teachings provide a method for manipulating an object with a remote vehicle having an end effector attached to a manipulator arm. The end effector comprises a jamming material in a housing. The method comprises pressing the end effector housing to the object, activating the jamming material to grasp the object, and moving the manipulator arm to manipulate the object.

Certain embodiments of the present teachings provide a device for allowing a remote vehicle having a manipulator arm to manipulate an object. The device comprises an end effector configured for attachment to the manipulator arm and comprising a housing and a jamming material within the housing, and a device for activating the jamming material. The object is manipulated by pressing the end effector housing to the object, activating the jamming material to grasp the object, and moving the manipulator arm.

Certain embodiments of the present teachings provide a device for allowing a remote vehicle to manipulate an object. The device comprises at least one housing connected to the remote vehicle and movable by the remote vehicle, the housing having an interior space in which a jamming material is held, and a device for activating the jamming material, the device being in communication with the interior space of the at least one housing. The object is manipulated by pressing the at least one housing to the object, activating the jamming material to grasp the object, and moving the at least one housing.

Additional objects and advantages of the present teachings will be set forth in part in the description which follows, and in part will be obvious from the description, or may be learned by practice of the present teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate several embodiments of the present teachings and together with the description, serve to explain the principles of the present teachings.

### BRIEF DESCRIPTION OF THE DRAWINGS

FIGS. 1A-1D include a schematic diagram of an exemplary embodiment of the present teachings, wherein an end effector picks up a target object.

FIGS. 2A-2D include a schematic diagram of another exemplary embodiment of the present teachings, wherein a two-part end effector picks up a target object.

FIG. 3 is a flow chart illustrating an exemplary jamming process in accordance with the present teachings;

FIG. 4 is a flow chart illustrating an exemplary unjamming process in accordance with the present teachings;

FIG. 5 is a schematic diagram illustrating an exemplary embodiment of various components used for manipulation via volume-change jamming or other phase change solidification in accordance with the present teachings;

FIG. 6 is a flow chart illustrating exemplary remote vehicle behaviors utilized in grasping and transporting an object with an end effector in accordance with the present teachings;

FIG. 7 is a flow chart illustrating exemplary remote vehicle behaviors utilized in grasping and turning a door knob with an end effector in accordance with the present teachings; and

FIGS. 8A-8C illustrate an exemplary embodiment of remote vehicle door opening utilizing an end effector in accordance with the present teachings.

### DESCRIPTION OF EXEMPLARY EMBODIMENTS

Reference will now be made in detail to the present teachings, exemplary embodiments of which are illustrated in the accompanying drawings.

A myriad of sensing capabilities, strength, and flexibility in the human hand make it adaptable for many applications. While roboticists have been building bio-mimetic grippers, few have come close to reproducing the human hand's capabilities. The present teachings offer a simplified gripping/gasping solution, providing a deformable end effector on a remote vehicle's manipulator arm (e.g., at its distal end) that can deform to a given extent to a target object's shape. Thereafter, the end effector's rigidity can be increased to grasp the target object.

The end effector can be attached to a remote vehicle manipulator arm and include a substantially air-impermeable housing that is filled with a jamming material. The housings can be substantially air-impermeable, although the composition of the housing can vary depending on the desired manipulation traits, the material contained in the housing, the size of the housing, and economic considerations. The material comprising the housing(s) should be at least minimally elastic or flexible and can have some degree of friction on its surface to aid in object manipulation. It should also have a strength (e.g., tear resistance) that is sufficient for objects it is intended to manipulate. For example, a more tear resistant material is desirable when objects to be manipulated may have sharp edges or points, whereas tear resistance can be less critical when objects to be manipulated are smooth.

In accordance with various embodiments, the housing can comprise, for example, a balloon such as a latex balloon, a platinum-cure or tin-cure silicone based rubber, a plastic bag such as a zip lock bag, or a Kevlar composite. Kevlar can provide strength against puncturing and can be combined with a more elastic material to attain a desired flexibility for the housing. Platinum-cure or tin-cure RTV (room temperature vulcanizing) silicone based rubbers can be desirable because they are easily molded into custom shapes. The housing can surround the jamming material and an activation device can be in communication with the jamming material.

The present teachings contemplate utilizing a high-friction material for the housing comprising, for example, soft elastomeric materials that can stretch and fold to maintain maximum surface area contact with the object to be gasped so that the friction (compressive) force applies over a large surface contact area. The high-friction material can also or alternatively comprise a material whose surface has bumps or a dense array of tendrils or hair that can help increase surface area contact. High-friction material, while not required, can increase grasp strength of an end effector.

Each housing need not comprise a single material, and can comprise a composite material, multiple layers having different compositions, or multiple panels/pieces having different compositions. Further, when multiple housings are used, each housing need not all have the same composition as other housings.

The phase change material within the end effector housing can comprise, for example, one or more of sand, foam, grain, salt, small spherical glass beads, ground coffee, silica desiccant, complex fluids, or other granular materials. While spherical particles generally flow better, aspherical particles (e.g., coffee grounds) can provide a stronger grasp of the target object better. The present teachings contemplate using one or more types and/or sizes of phase change material(s) in the end effector housing, the constituency of the phase change material(s) within the housing being customizable based, for example, on a desired application's flow, strength, and other gripping/grasping characteristics.

The housing can surround the phase change material and an activation device can be placed in communication with the jamming or other phase change material(s). Jamming is the physical process by which some materials, such as sand, foams, grain, salt, small spherical glass beads, ground coffee, silica desiccant, complex fluids, and/or other granular materials become rigid, for example with increasing density. The jamming transition has been proposed as a new type of phase transition, with similarities to a glass transition but which is different from the formation of crystalline solids. While a glass transition occurs when the liquid state is cooled, the jamming transition happens upon an actuation event, for example when density is increased. This crowding of the constituent particles prevents them from exploring phase space, making the aggregate material behave as a solid. The jamming system of the present teachings preferably is able to unjam.

Regarding jamming, while many materials experience discrete liquid and solid behavior, granular matter, for example such as sand or glass particles or ground coffee, can easily switch between liquid and solid behavior. When a granular material such as coffee grounds is jammed, such as by vacuum packing, it becomes tightly packed and free volume is too small for the particles to move, leading to a solid-like behavior by the coffee grounds. When the vacuum seal is broken, the coffee grounds can again behave like a liquid as particles flow past one another. This gives a desirable property of selective deformability and rigidity that can be utilized for object grasping and manipulation, such as for use in an end effector of a remote vehicle manipulator arm.

In accordance with certain exemplary embodiments of the present teachings, the phase change material includes coffee grounds or structurally-similar particles (e.g., glass or sand particles in a fluid such as air or water) that are activated by a volume change.

Other phase change materials can be used in an end effector in accordance with the present teachings. One such material is a dilatant material such as a combination of cornstarch and water (sometimes referred to as oobleck), which can be activated to a more solid state via application of vibration. A dilatant (also called shear thickening) material is one in which viscosity increases with the rate of shear. The dilatant effect is believed to occur when closely-packed particles are combined with enough liquid to fill the gaps between them. At low velocities, the liquid acts as a lubricant, and the dilatant flows easily. At higher velocities, the liquid is unable to fill the gaps created between particles, and friction greatly increases, causing an increase in viscosity.

Other materials that are not truly phase change materials, but which are contemplated for use in an end effector in accordance with certain embodiments of the present teachings, can include electrorheological (ER) fluids and magnetorheological (MR) fluids. ER fluids are suspensions of extremely fine non-conducting particles (up to, for example, 50 micrometers in diameter) in an electrically insulating fluid. The apparent viscosity of these fluids can change reversibly by an order of up to 100,000 in response to an electrical field. An MR fluid is a suspension of micrometer-sized magnetic particles in a carrier fluid, usually a type of oil. When subjected to a magnetic field, the fluid greatly increases its viscosity, to the point of becoming a viscoelastic solid. The yield stress of the fluid when in its active (“on”) state can be controlled very accurately by varying the magnetic field intensity.

Yet another phase change material can include supersaturated sodium acetate solutions that, when heated to around 100° C. and subsequently allowed to cool, become supersaturated. This solution is capable of supercooling to room temperature without forming crystals and then, by application of a small amount of energy such as a mechanical shock, a nucleation center is formed and causes the solution to crystallize into a solid sodium acetate trihydrate. This solidification is reversible through application of heat.

Some of the materials referred to herein may be considered by certain people of skill in the art not truly undergo a “phase change.” Thus, the term “phase change materials” as used herein includes material, as described herein and as would be appreciated by those skilled in the art, which behaves as if it undergoes a phase change.

Devices used to actuate the jamming or other phase change material within the end effector housing will vary based on the type of phase change material and its mode of activation. For jamming materials that exhibit change from a solid-like state to a free-flowing state (and vise versa) based on a volume change (e.g., ground coffee), the actuation device can comprise, for example, a mechanical pump mechanism such as that described in U.S. Pat. No. 5,113,599 to Cohen et al., or an electric vacuum pump such as a Hargraves CTS Series Single Head Micro Diaphragm Pump and Compressor. In accordance with the present teachings, a volume change can also be facilitated by a fuel cell-powered vacuum pump such as that disclosed in U.S. Pat. No. 7,409,830 to Yerazunis et al.

For activating dilatant material, a low voltage, low current miniature vibrating motor can be utilized. The vibrating motor can, for example, operate on a 1-5 VDC motor with an offset weighted shaft, such as those used in cell phones and pagers for a vibrating alert signal. Electrical plates, for example one inside of the housing and one outside of the housing, can be used to activate ER material. Magnets located in or near the housing can be used to activate MR material by creating a magnetic field within the housing.

An exemplary ground coffee-filled balloon end effector embodiment and an exemplary method of use thereof is further discussed hereinbelow. It is to be understood that other embodiments of end effectors in accordance with the present teachings can be utilized in a similar manner although the housing, phase change material, and actuator type may vary. The actuator can, for example, be powered by a dedicated power source or a power source for the remote vehicle. The actuator can be located in a variety of locations, including adjacent to the housings or at another location preferably on the remote vehicle and its manipulator arm. Similarly, the power source can be located in a variety of locations, including adjacent to the actuator or at another location preferably on the remote vehicle and its manipulator arm.

In a method of using the device, the end effector housing (balloon) can be held at atmospheric pressure such that the jamming material (ground coffee) can flow in a liquid-like manner, making the end effector pliable. The housing can then be pressed onto a desired object such that it at least begins to conform to the object's shape, thus at least beginning to surround it. Air can then be evacuated from the housing a vacuum pump in fluid communication with an interior of the housing, creating a negative pressure within the housing that decreases the housing's volume so that the ground coffee particles becomes packed tightly together and behave in certain aspects as a solid, making the end effector rigid. In certain embodiments of the present teachings, the ground coffee can be activated to varying degrees—for example by varying the volume change within the end effector housing—to adjust the stiffness of the end effector. The amount of air removed from the housing for sufficient activation can depend, for example, on the size of the housing and the amount and type of material therein.

In certain exemplary embodiments, the end effector can comprise one or more housings, for example latex balloons, filled with coffee grounds. The housings are attached to an end of a remote vehicle's manipulator arm, for example a manipulator arm of an iRobot® PackBot®. For ease of understanding and without intending to limit the scope of the claimed invention, an exemplary coffee ground-filled balloon embodiment is described hereinbelow to illustrate a method of the present teachings. One skilled in the art will appreciate, however, that other types of suitably impermeable housings can be employed instead of or in addition to a balloon as set forth above. Similarly, other materials having properties allowing them to “jam” can be employed in place of coffee grounds, as set forth above.

In an exemplary embodiment of the present teachings, an end effector housing (e.g., the balloon) is hooked up to a small vacuum, for example via a vacuum line or other piping. When the vacuum line is closed, the chamber formed by the housing and vacuum line forms a substantially air-tight environment in which the phase change material (e.g., the ground coffee) is held. In a resting or non-activated state in which, for example, the inside of the housing is at atmospheric pressure, the coffee ground-filled housing is flexible and compliant, in a manner similar to a beanbag. In this state, the housing can be pressed to an object to be manipulated (e.g., a pencil, tool, doorknob, etc.). Air can then be evacuated from the housing and, due to a jamming effect, the coffee grounds can become rigidly bound to the shape of the objected they have surrounded (i.e., the object to be manipulated). The rigidity caused by jamming is preferably at least sufficient to give the end effector housing a conformal grasp on the object.

Once the end effector has grasped the object, the end effector can be manipulated by moving the remote vehicle's manipulator arm.

To release the object from the end effector housing, air can be allowed back into the housing, for example allowing the interior of the housing to return to atmospheric pressure. Using this approach, instead of trying to precisely align and place multiple gripper fingers on or around an object to grasp the object, an operator need only press or place the end effector onto an object. Thus, precise positioning and complex, high degree-of-freedom grippers are not needed to grasp and manipulate even small objects such as pencils or complex objects such as door knobs.

Certain embodiments of the present teachings, the end effector housing can comprise a high-friction material instead of, or in addition to, the exemplary housing material described above such as a latex balloon, a platinum-cure or tin-cure silicone based rubber, a plastic bag such as a zip lock bag, or a Kevlar composite. The high-friction material can comprise, for example, soft elastomeric materials that can stretch and fold to maintain maximum surface area contact with the object to be gasped. The high-friction material can also or alternatively comprise a material whose surface has bumps or a dense array of tendrils or hair that can help increase surface area contact. High-friction material can increase grasp strength of a end effector. The high friction material can be placed on an outer surface of the housing, for example over one or more portions of the housing surface as desired.

The present teachings also contemplate providing or integrating pressure sensors in or on the end effector for determining how the end effector's shape changes upon being placed/pressed onto the object. Recognizing a change in end effector shape can facilitate determination of a certain amount of the 3D geometry of the object being grasped. Determining a certain amount of the 3D geometry of the object being grasped can assist an operator in determining whether the end effector has a suitable grasp on an object, and/or how best to grasp and move the object. As an example, knowing the object geometry can assist the operator in determining whether an object extends beyond the end effector and where the object's center of mass is, which can be useful knowledge for manipulating the object.

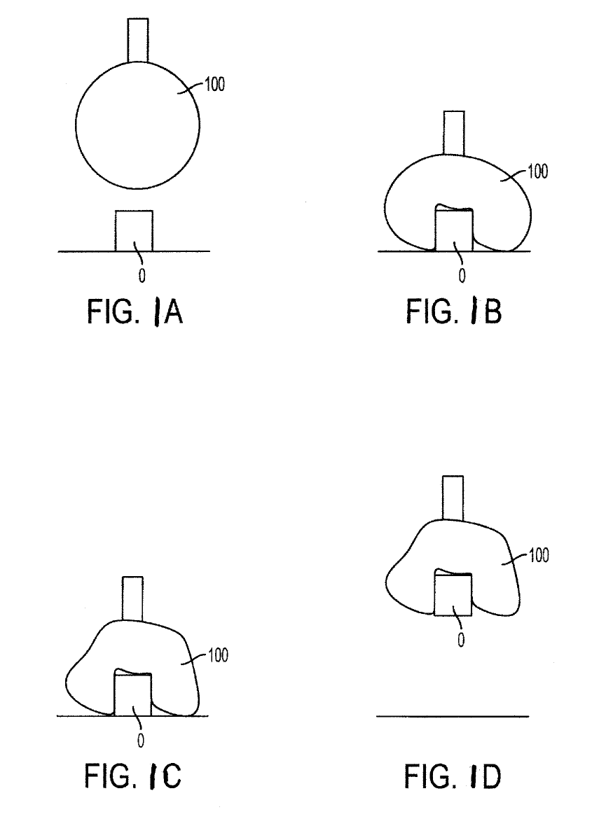

FIGS. 1A-1D include a schematic diagram of an exemplary embodiment of the present teachings wherein a one-piece end effector 100, for example located on a remote vehicle manipulator arm, picks up an object O. The remote vehicle, pneumatics, motors, and electronics are omitted for simplicity. In FIG. 1A, the end effector 100 is pliable (e.g., for embodiments realizing jamming via volume change, the housing is at atmospheric pressure) and therefore can wrap around at least a portion of an object O to be grasped. In FIG. 1B, the end effector 100 has surrounded a portion of the object O to be grasped. In FIG. 1C, the end effector 100 becomes rigid, for example by a volume change (e.g., removing fluid from the housing via a vacuum) and grips the object O, thus being able to lift the object O as illustrated in FIG. 1D. Depending on the shape and composition of the housing, the housing material can shrink a small amount due to evacuation of volume in the housing, creating a slight compressive force on the object to be grasped. This compressive force is the normal force necessary for friction to allow grasping and manipulation of the object. The end effector and thus the gripped object can then be moved by the remote vehicle manipulator arm and can be released, for example, by allowing the material within the end effector housing to unjam (e.g., for materials such as coffee grounds that phase change via volume change, by allowing the interior of the housing to return to atmospheric pressure).

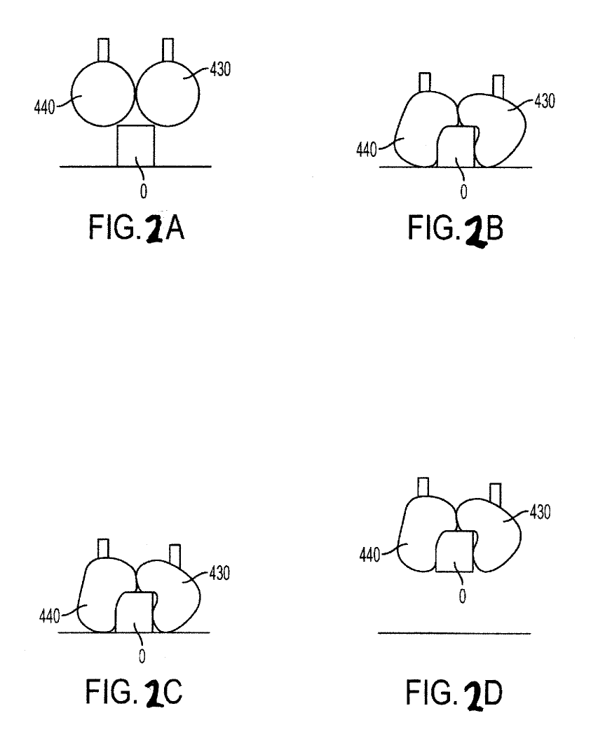

FIGS. 2A-2D include a schematic diagram of another exemplary embodiment of the present teachings wherein a two-part end effector, for example located on a remote vehicle manipulator arm, picks up an object O. In FIG. 2A, the end effector housings 430, 440 are pliable (e.g., for embodiments realizing jamming via volume change, the housings are at atmospheric pressure) and therefore can wrap around at least a portion of the object O. In FIG. 2B, the end effector housings 430, 440 are surrounding (here, cooperatively) a portion of the object O to be grasped. In FIG. 2C, the end effector housings 430, 440 become rigid, for example by a volume change (e.g., removing air from the housings via one or more vacuums) and cooperated to grip the object O, thus being able to lift the object O as illustrated in FIG. 2D. Depending on the shape and composition of each housing, the housing material can shrink a small amount due to evacuation of volume in the housing, creating a slight compressive force on the object to be grasped. This compressive force is the normal force necessary for friction to allow grasping and manipulation of the object. The end effector and thus the gripped object can be then moved by the remote vehicle manipulator arm and can be released, for example, by allowing the material within the end effector housings to unjam (e.g., for materials such as coffee grounds that phase change via volume change, by allowing the interior of the housings to return to atmospheric pressure).

In the dual-housing end effector embodiment shown in FIGS. 2A-2D, the housings can have a diameter of, for example, from about a few millimeters to an inch or more. The housings in the illustrated embodiment are shown to be substantially spherical, for example similar to the shape of a standard type latex balloon. The present teachings contemplate a variety of sizes and shapes for the housings, as well as a variety of housing materials and a variety of jamming or other phase change materials as set forth above. The housings need not have the same size or shape as each other and need not comprise the same material as each other. Indeed, the housings need not be filled with the same jamming or other phase change material, although it can be desirable to use material that can be actuated by the same type of actuator in each housing, so that a single actuator or type of actuator can be provided for both housings if desirable.

In certain embodiments, an end effector in accordance with the present teachings can be used to open a door in the following manner. First, an unactuated end effector is pressed against a target door knob, deforming to a certain degree to accommodate a shape of the door knob. Next, the jamming or other phase change material is actuated, making the material behave as a solid that is grasping the door knob. Next, the end effector is rotated in a manner to rotate the door knob, via, for example, a pivot joint and a motor on the manipulator arm to which the end effector is attached. Once the door is unlatched by rotating the door knob, the door knob can be moved by, for example the remote vehicle and its manipulator arm, to open the door. Pulling or pushing of the door knob is accomplished by moving the manipulator arm in an appropriate direction (e.g., forward and backward).

The present teachings contemplate using the end effector of the present teachings to grasp and rotate a variety of door handle types, including a lever-type of door handle. Also, similar to the way a door knob can be grasped, rotated, and pulled or pushed, an end effector in accordance with the present teachings can grasp an object and tow it or plow it.

It is to be understood that the embodiments of the present teachings illustrated in FIGS. 1A-1D and 2A-2D are exemplary only. The end effector and its constituent housing(s) need not have the illustrated shape or size. The size and shape of the end effector can vary to optimize manipulation for an intended use, or for reasons of durability or economy. In addition, the resting pliability of the end effector can vary, which can vary the end effector's ability to surround the object to be manipulated when at rest or not activated. For jamming via volume change, the end effector can be at rest when the housing(s) are at atmospheric pressure and are pliable. The housing(s) can be activated by air evacuation, making them rigid to grip the object. For jamming via introduction of an electric or magnetic field with, for example, a device such as a battery or other power source that can be switched on and off, the end effector can be at rest when no electric current is applied to the jamming material.

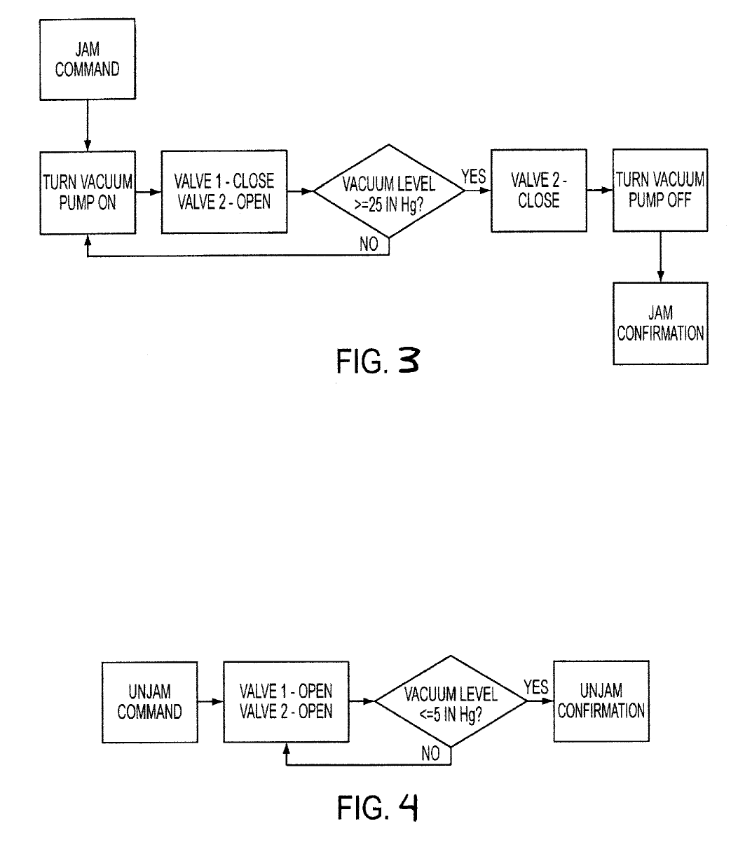

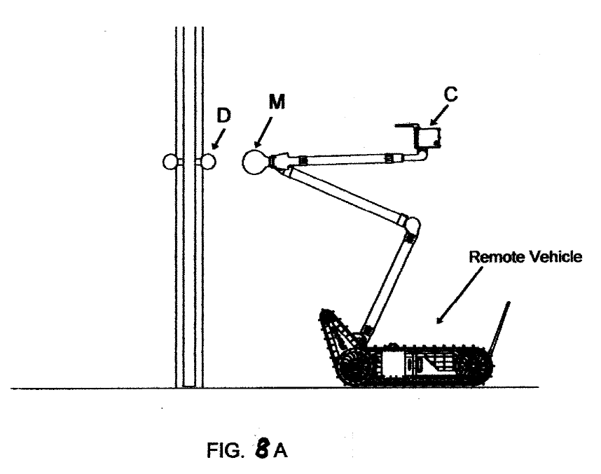

FIG. 3 is a flow chart illustrating an exemplary jamming process in accordance with the present teachings, wherein the jamming or other phase change material comprises coffee grounds or another material that exhibits a solid-like behavior upon evacuation of air or another fluid with which it is combined. Jamming can be initiated with a jam command received, for example, by the remote vehicle controller from, for example, an operator control unit. Transmission, receipt, and implementation of such a command can be accomplished in a manner similar to transmission, receipt, and implementation of other teleoperation commands. Upon receipt of the jam command, a vacuum pump (see FIG. 5) can be turned on and a valve (e.g., Valve 1 in FIG. 5) connecting the housing with a low pressure vent (see FIG. 5) can be closed to allow evacuation of air or other fluid from the housing to cause jamming. A low pressure vent can return the housing to an atmospheric pressure. The present teachings do not require use of a low pressure vent, although use of such a vent can allow the housing interior to return to atmospheric pressure more quickly. To unjam the material, a valve can merely connect the housing with the surrounding environment.

In the exemplary embodiment of FIG. 3, the vacuum pump only turns on if the vacuum level in the housing is less than 25 in. Hg. This is because, if the vacuum level in the housing is greater than or equal to 25 in. Hg, the housing already has the desired level of vacuum for this embodiment. If turned on, the vacuum pump is kept on until the vacuum level in the housing becomes equal to or greater than 25 in. Hg. Pressure in the housing is measured, for example, by a pressure sensor within or otherwise connected to the housing (see FIG. 5). When the pressure sensor indicates that the pressure in the housing is greater than or equal to 25 in. Hg, a valve connecting the vacuum pump with the housing can be closed to retain the desired pressure in the housing and the vacuum pump can be turned off. Jamming is “confirmed” when a desired pressure in the housing (e.g., 25 in. Hg) is indicated by the pressure sensor. Confirmation can be sent to the operator via a signal to the operator control unit. The rate of evacuation of air from the housing can be dependent upon the pump being used. In certain embodiments, evacuation to a vacuum level of 25 in. Hg can occur in a second or less, for example in a housing having a diameter of less than five inches.

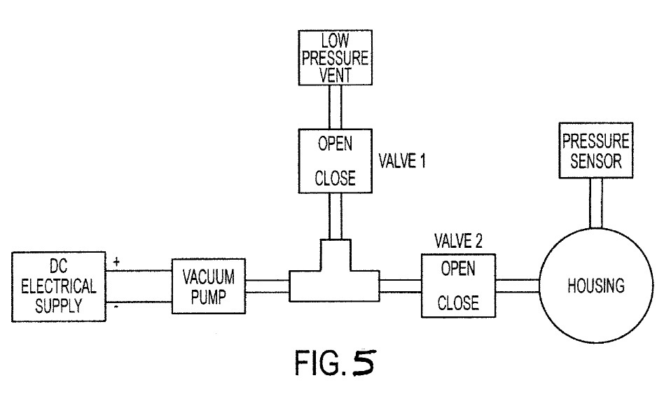

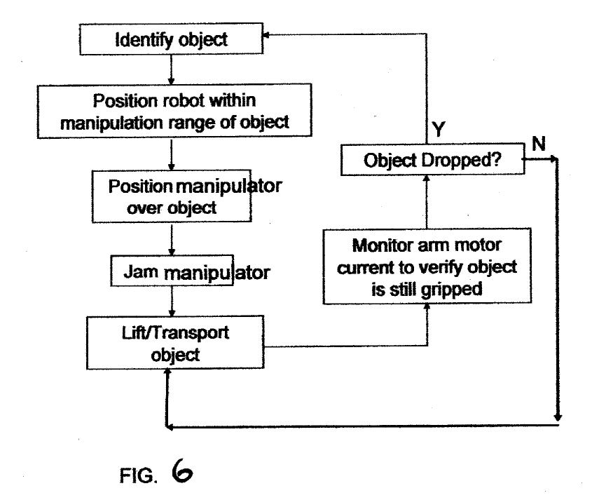

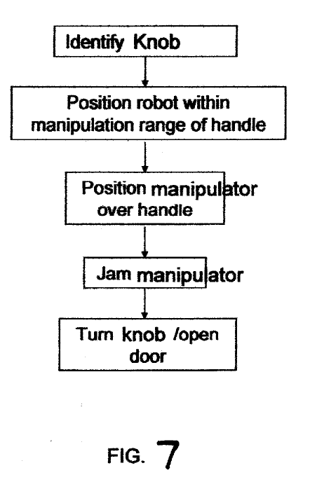

FIG. 4 is a flow chart illustrating an exemplary unjamming process in accordance with the present teachings, wherein the jamming or other phase change material comprises coffee grounds or another material that exhibits a solid-like behavior upon evacuation of air or another fluid with which it is combined. Unjamming is initiated with an unjam command that is received, for example, by the remote vehicle controller from, for example, an operator control unit. Transmission, receipt, and implementation of such a command can be accomplished in a manner similar to transmission, receipt, and implementation of other teleoperation commands. Upon receipt of the unjam command, a valve (e.g., Valve 1 in FIG. 5) can be opened, connecting the housing with the low pressure vent to allow an exchange of air or other fluid with the housing to cause the housing to return to an unjammed state, for example atmospheric pressure when coffee grounds are used as a jamming or other phase change material. The low pressure vent can provide controlled access to the external environment or another non-vacuum environment. In the exemplary embodiment of FIG. 4, when the vacuum level in the housing is less than or equal to 5 in. Hg, unjamming of the end effector can be confirmed. The valve leading to the low pressure vent need not, however, be closed upon confirmation of unjamming. Unjamming is “confirmed” when a desired pressure in the housing (e.g., 5 in. Hg) is indicated by the pressure sensor. Confirmation may be sent to the operator via a signal to the operator control unit.

FIG. 5 is a schematic diagram illustrating an exemplary embodiment of various components used for manipulation via volume-change jamming or other phase change solidification in accordance with the present teachings. As shown, a vacuum pump is powered by a DC electrical supply and connected (e.g., via pneumatic tubing) with the housing. Also connected with the housing (e.g., via pneumatic tubing) is a low pressure vent that can, in certain embodiments, be employed to control access to the external environment or another non-vacuum environment. A valve (Valve 1) can be provided between the low pressure vent and the housing. Valve 1 can have opened and closed positions. Another valve (Valve 2) can be provided between the housing and both the vacuum pump and the low pressure vent. When Valve 1 and Valve 2 are open, the housing can be held at atmospheric pressure such that the jamming or other phase change material can flow in a liquid-like manner, making the end effector pliable. When Valve 1 is closed and Valve 2 is open and the vacuum pump is turned on, the vacuum pump can remove air from the housing making the jamming or other phase change material behave as a solid. Closing Valve 2 can allow, for a housing without leakage, the housing to remain jammed indefinitely.

Regarding the 25 in. Hg and 5 in. Hg vacuum levels, these levels are exemplary only, as jamming and most other phase changes don't turn “on” and “off,” but rather the modulus of the material varies—sometimes nearly linearly—with the vacuum level. Thus, the vacuum levels selected for jamming and unjamming for a given implementation will be chosen based on a desired pliability and stiffness of the housing.

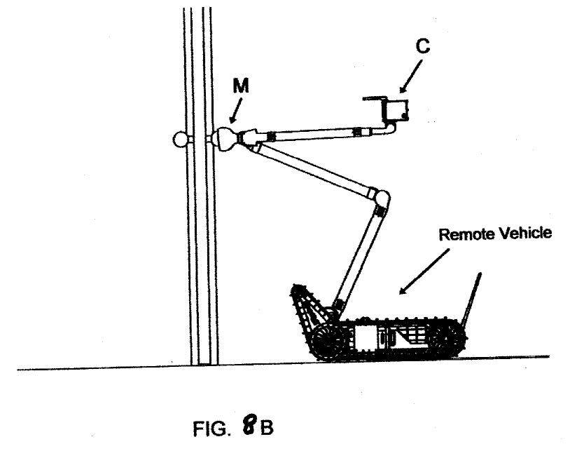

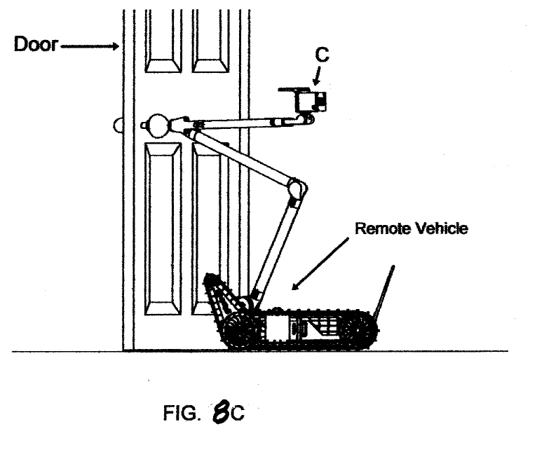

FIG. 6 is a flow chart illustrating steps for grasping and transporting an object with an end effector in accordance with certain embodiments of the present teachings. Initially, the object to be manipulated can be identified. The axis of rotation of the knob and its turning direction can also be identified.

After the object is identified, the remote vehicle can be positioned within a manipulation range of the object, for example by a teleoperator controlling the remote vehicle. Next, the end effector can be positioned over or proximate to the object and then pressed to it to conform to its shape. Upon proper positioning, the end effector can be jammed to cause the jamming or other phase change material within the housing to behave as a solid and grasp the object. Upon jamming, the manipulator arm and/or the remote vehicle can be moved to transport the object, for example via teleoperation. Thereafter, grasping of the object can be verified, for example by monitoring the current to the manipulator arm to confirm that a constant load is applied to the arm (i.e., that the arm continues to carry the load of the grasped object). If the object has been dropped, the object can again be identified and the grasping and transport repeated.

FIG. 7 is a flow chart illustrating steps for grasping and turning a door knob with an end effector in accordance with certain embodiments of the present teachings. FIGS. 8A-8C illustrate exemplary manipulation of a door knob. Initially, the door knob to be manipulated is identified. Thereafter, the remote vehicle is positioned within a manipulation range of the door knob, for example by a teleoperator controlling the remote vehicle. Next, the end effector can be positioned over or proximate the door knob and then pressed to it to conform to a shape of the door knob. Upon proper positioning on the door knob, the end effector can be jammed to cause the jamming or other phase change material within the housing to behave as a solid and grasp the door knob. Upon jamming, the end effector, for example via the manipulator arm, can be rotated to turn the door knob, for example via teleoperation. Although not illustrated, similar to the behavior flow chart illustrated in FIG. 6, if the end effector loses its grip on the door knob (which can be determined, for example, by a teleoperator viewing the knob or by tracking current to a motor controlling rotation of the door knob), the door knob can again be identified and the gripping and rotation repeated.

As stated above, FIGS. 8A-8C illustrate an exemplary embodiment of an end effector consistent with the embodiment of FIGS. 1A-1D being utilized to open a door in accordance with certain embodiments of the present teachings. In FIG. 8A, the remote vehicle approaches a door having a door knob D. As can be seen, in the remote vehicle embodiment depicted, a camera or other viewing device C allows a teleoperator (or behavioral software) to “see” the environment of the end effector M to guide the end effector M toward the door knob. In FIG. 8B, the end effector housing is pressed to the door knob D, conforming at least partially to its shape, and the jamming or other phase change material is activated to act as a solid, causing the end effector M to grasp the door knob D. The door knob can then be rotated by the end effector M to unlatch the door. After the door has been unlatched by rotating the door knob, the remote vehicle and/or the manipulator arm can be moved (see FIG. 8C) to cause the end effector M pull or push the door into an open position.

Regarding the rotational force necessary to rotate a door knob to unlatch a door, in accordance with certain embodiments, the end effector can be capable of applying a torque of, for example, between 0.5 ft-lb and 1.5 ft-lb of torque. However, as will be understood by those skilled in the art, the present teachings contemplate utilizing a broader range of torques as necessary for a given application and/or for varied types of knobs.

Utilizing a remote vehicle equipped with a n end effector embodiment in accordance with the present teachings need not substantially change the main manipulation tasks of missions executed by such a remote vehicle, for example an IED disposal mission. Utilization of the end effector would simply make the task of object manipulation during the mission faster and less complex. It should be noted that, with prior art remote vehicles having conventional grippers, the general approach direction of the grippers is important to ensure that the remote vehicle's manipulator arm has a proper range of motion to swing the door open as necessary after unlatching the door knob. However, when utilizing an end effector in accordance with the present teachings, the direction of approach is not nearly as important, because the end effector can conform to the handle or maximizes surface contact with the object so long as the housing(s) overlap sufficiently with the knob so that the housing(s) can sufficiently grip the door knob when jammed and apply the required amount of torque for the door knob to be opened.

The present teachings also contemplate a controller, and utilization thereof, for controlling an end effector to be used on a manipulator arm of a remote vehicle to manipulate an object. The controller can facilitate manual control of the end effector, providing proportional haptic feedback (e.g., a vibration felt by the operator) when the end effector touches the object. The controller can also provide a second haptic feedback indicative of sufficient grasping of the object by the end effector. The second feedback can comprise, for example, pressure against the controller's hand or other physical feedback that can be understood by the controller to indicated that the end effector has jammed or is sufficiently grasping an object. Such haptic feedback can include, for example, constriction of the controllers hand, wrist, or finger in a manner that suggests the end effector's gripping.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method for manipulating an object with a remote vehicle having an end effector attached to a manipulator arm, the end effector comprising a jamming material in a housing, the method comprising:
pressing the end effector housing to the object,
activating the jamming material to grasp the object; and
moving the manipulator arm to manipulate the object.

2. The method of claim 1, wherein activating the jamming material comprises changing an air volume in the end effector housing.

3. The method of claim 2, wherein the jamming material is coffee grounds.

4. The method of claim 2, wherein a vacuum is in fluid communication with the end effector housing and changes the air volume in the effector housing.

5. The method of claim 2, wherein, prior to activating the jamming material, an interior of the housing is at atmospheric pressure and the end effector is pliable.

6. The method of claim 5, wherein, after activating the jamming material, an interior of the housing is at a negative pressure and the end effector is rigid.

7. The method of claim 1, wherein activating the jamming material comprises introducing an electric or magnetic field to the jamming material.

8. The method of claim 1, wherein the housing comprises a balloon.

9. The method of claim 1, wherein the housing comprises a high-friction material.

10. A device for allowing a remote vehicle having a manipulator arm to manipulate an object, the device comprising:
an end effector configured for attachment to the manipulator arm and comprising a housing and a jamming material within the housing; and
a device for activating the jamming material,
wherein the object is manipulated by pressing the end effector housing to the object, activating the jamming material to grasp the object, and moving the manipulator arm.

11. The device of claim 10, wherein the device for activating the jamming material comprises a vacuum in fluid communication with the housing, the vacuum changing an air volume in the housing.

12. The device of claim 11, wherein the jamming material is coffee grounds.

13. The device of claim 11, wherein, prior to activating the jamming material, an interior of the housing is at atmospheric pressure and the end effector is pliable.

14. The device of claim 13, wherein, after activating the jamming material, an interior of the housing is at a negative pressure and the end effector is rigid.

15. The device of claim 10, wherein the device for activating the jamming material comprises a device for introducing an electric or magnetic field to the jamming material.

16. The device of claim 10, wherein the housing comprises a balloon.

17. The device of claim 10, wherein the housing comprises a high-friction material.

18. A device for allowing a remote vehicle to manipulate an object, the device comprising:
at least one housing connected to the remote vehicle and movable by the remote vehicle, the housing having an interior space in which a jamming material is held; and
a device for activating the jamming material, the device being in communication with the interior space of the at least one housing,
wherein the object is manipulated by pressing the at least one housing to the object, activating the jamming material to grasp the object, and moving the at least one housing.

19. The device of claim 18, wherein, prior to activating the jamming material, the interior space of the at least one housing is at atmospheric pressure and the at least one housing is pliable.

20. The device of claim 19, wherein, after activating the jamming material, the interior space of the at least one housing is at a negative pressure and the t least one housing is rigid.
